(19) United States
(12) Patent Application Publication
(10) Pub. No.: US 2006/0153181 A1
(43) Pub. Date: Jul. 13, 2006

(54) Incremental redundancy memory

(76) Inventor: Xiaofeng Wu, Neubiberg (DE)

Correspondence Address: JENKINS, WILSON, TAYLOR & HUNT, P. A., 3100 TOWER BLVD, SUITE 1200, DURHAM, NC, 27707, US

(21) Appl. No.: 10/532,355

(22) PCT Filed: Dec. 9, 2003
(86) PCT No.: PCT/EP03/13966

§ 371 Date: Sep. 7, 2005

(30) Foreign Application Priority Data
Dec. 9, 2002 (DE) 102 57 463.4

(51) Int. Cl. H04L 12/56

(52) U.S. Cl. 370/389

(57) ABSTRACT

IR memory for an EGPRS receiver of a mobile station which receives data from a base station, by means of a data transmission channel, whereby the IR memory comprises a first memory region, for the buffering of a Particular number of data blocks with a given first data resolution and a second memory region for the buffering of erroneously-decoded data blocks. The second memory region stores the erroneously-decoded data blocks with a second data resolution which is lower than the first data resolution.

The invention relates to an IR (incremental redundancy) memory for an EGPRS (enhanced general packet radio service) receiver of a mobile station, which receives data from a base station (BS) via a data transmission channel.

In the context of further development of GSM, a packet-oriented service concept for data transmission has been developed by the ETSI in recent years. The standardization of the new general packet radio service (GPRS) has largely been concluded since 1997. The GPRS standard is currently being extended in the context of the standardization of Enhanced Data Rates for GSM Evolution (EDGE) with respect to the enhanced EPRS standard (GPGRS).

EDGE enables data transmission rates and spectral efficiency to be increased and thus enables new applications for mobile stations.

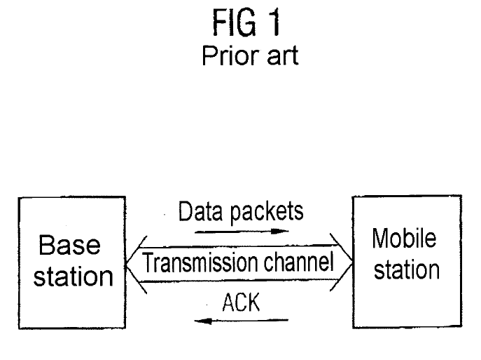

FIG. 1 schematically shows a base station and a mobile station according to the prior art. The base station (BS) sends data packets via the transmission channel to the mobile station (BS), which acknowledges reception of the data with an acknowledgement signal ACK. The data are transmitted in a manner coded as data blocks from the base station BS to the mobile station MS. The channel coding used in the case of EDGE is MCS (modulation and coding scheme) coding. In this case, a distinction is made between MCS-1 to MCS-9 as coding schemes. The lower four coding schemes (MCS-1 to MCS4) use GMSK modulation, while the five further coding schemes (MCS-5 to MCS-9) use 8 PSK modulation. The basic unit for data transmission is a 20 ms long data block that is divided into four GSM data bursts and is transmitted by means of four TDMA frames.

A dynamic link adaptation is furthermore used in the case of EDGE. In this case, the connection quality is measured by the mobile station (MS) in the case of a downlink connection or by the base station (BS) in the case of an uplink connection and the best suited modulation and coding scheme is selected for the data transmission of the next sequence of data packets. In this case, the adaptation of the modulation and coding scheme depends on the signal to interference and noise ratio (SINR).

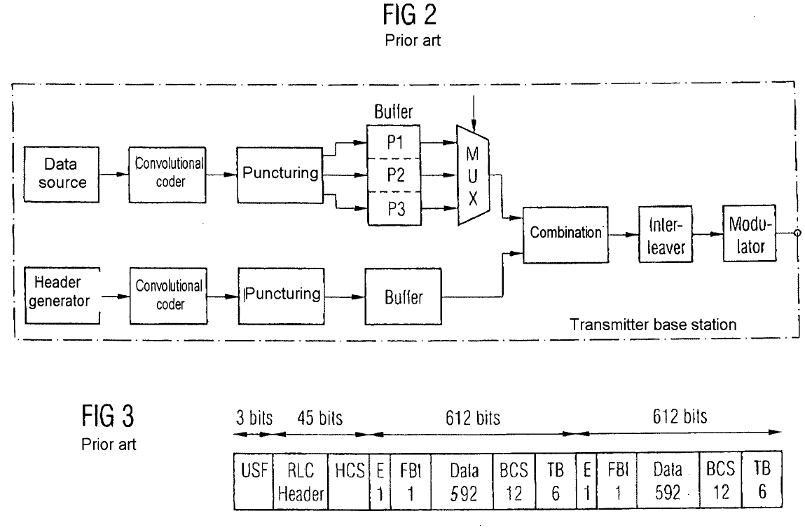

FIG. 2 shows a block diagram of a transmitter within the base station according to the prior art. The data originating from a data source are fed as data blocks, for example as RLC data blocks, to a convolutional coder. The convolutional coder carries out a convolutional coding of the data blocks, which are output to a puncturing circuit.

Puncturing is a method for shortening the convolutional codes generated. In this case, one or more locations are deleted from the output bit stream of the convolutional coder according to a predetermined scheme of the so-called puncturing table. In this case, a puncturing table comprises the data elements 0 and 1 and is processed periodically. A 0 means not transmitting the received bit in the output bit stream, and a 1 in the puncturing table means transmitting the bit received from the convolutional coder in the output bit stream. The coded data sequence is thereby shortened. A part of the redundancy added by the convolutional coder is removed again by means of the puncturing, i.e. the coding rate decreases. The puncturing device makes it possible to implement different coding rates. Proceeding from a mother code of rate 1/n, codes having a higher code rate can be achieved by means of periodic puncturing.

In the case of the embodiment illustrated in FIG. 2, the bit stream output by the convolutional coder is punctured using three different puncturing tables P1, P2, P3. The differently punctured data streams are stored in a buffer memory.

The header data generated by a header generator are in the same way coded by a convolutional coder and subsequently punctured. The punctured header data are stored in a buffer memory and subsequently combined with the buffer-stored punctured data P1, P2 or P3 to form a data block. The data block is scrambled by an interleaver circuit and, after modulation by a modulator, sent to the mobile station MS via the data transmission channel.

FIG. 3 shows a data packet output by a data source and having two RLC blocks comprising 612 bits, said blocks in each case containing 592 data bits in accordance with the modulation and coding scheme MCS-9. The header data USF (uplink state flag), the RLC header and the header check data sequence HCS (header check sequence) are followed by two RLC data blocks within 20 ms. Besides the 592 data bits, the RLC data blocks comprise a final block indicator FBI, a block check data sequence BCS (block check sequence) and 6 TB data bits.

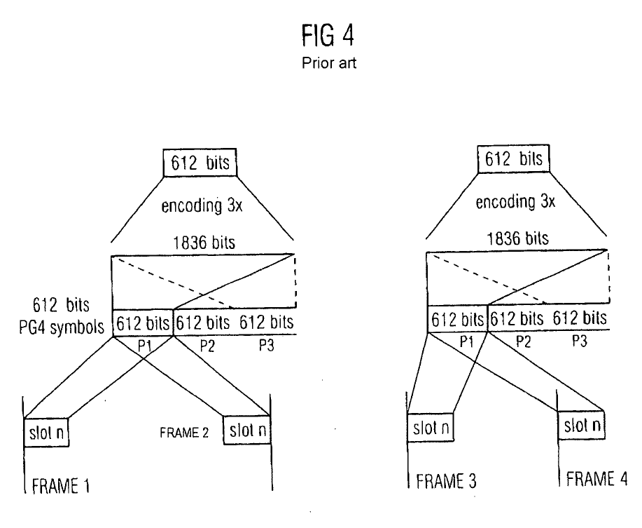

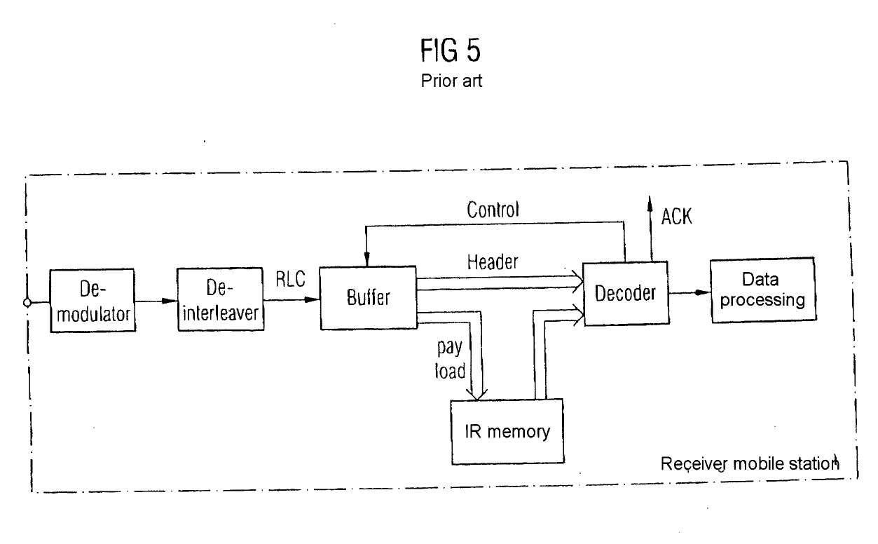

FIG. 4 shows the coding and puncturing of the RLC data blocks in accordance with the MCS-9 coding scheme according to the prior art. Each of the two RLC data blocks is coded by the convolutional coder with a coding rate 1/3 to give 1836 data bits. These data bits are subsequently punctured by the puncturing device using three different puncturing schemes P1, P2, P3, thus giving rise to three differently punctured data blocks P1, P2, P3 each having 612 bits. If three data bits represent a data symbol to be transmitted, this corresponds to 204 data symbols per punctured data block. The punctured data blocks are transmitted in a time slot within a frame. As illustrated in FIG. 4, the data bits punctured in accordance with the puncturing scheme P1 are transmitted in a time slot n within four successive data frames. The data bits punctured in accordance with the puncturing schemes P2, P3 are transmitted in response to a request signal from the mobile station (ARQ=automatic request).

FIG. 5 shows the receiver of a mobile station MS according to the prior art. The receiver contains an IR (incremental redundancy) memory. Incremental redundancy is a coding scheme in which the transmitted redundancy is increased incrementally step by step. First of all, the data bits are transmitted with low error protection without taking account of the current quality of the radio data transmission channel. If the information is not received without any errors on the part of the receiver, additional information is transmitted and linked with the previously received information items in the receiver. The linking of the soft outputs of the differently punctured versions of the RLC data block significantly increases the decoding performance. The operation is repeated until the transmitted information is sufficient for decoding by the receiver. By means of incremental redundancy, the effective coding rate is effectively adapted to the signal to interference and noise ratio (SINR) of the data transmission channel.

The received RLC data blocks are buffer-stored in an incremental redundancy memory of the receiver. The IR memory principally serves for buffering the soft information of the incorrectly decoded RLC blocks while the receiver waits for the renewed transmission of the additionally required information or data.

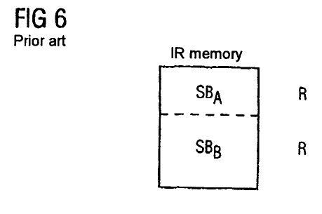

FIG. 6 schematically shows an IR memory according to the prior art. The IR memory according to the prior art comprises a first memory area SB_{A} and a second memory area SB_{B}. The first memory area SB_{A} serves for buffer-storing a specific number of RLC data blocks with a predetermined data resolution R. The required memory space for the first memory area SB_{A} results from the internal time delay within the receiver of the mobile station, more precisely the time delay between the channel equalizer and the channel decoding. In the case of a present-day edge receiver, the time delay from the equalizer to the start of the channel decoding of the corresponding RLC data amounts to approximately 8 RLC data blocks. Therefore, a time delay of X_{D} of approximately twelve RLC data blocks may be regarded as sufficient. The first memory area SB_{A} takes account of the internal time delay within the receiver of the mobile station.

The second memory area SB_{B} within the IR memory according to the prior art serves for storing the erroneously decoded RLC data blocks. The number of erroneously decoded RLC data blocks depends on the round trip delay and the polling period of the data transmission channel. Since it is necessary to transmit two RLC data blocks of 612 bits or 204 data symbols in each case within 20 ms for the case of a 1 time slot (MCS-9), a realistically assumed round trip delay of 120 ms corresponds to a memory space requirement of (120 ms: 20 ms×2×N_{TS})=12×N_{TS} RLC data blocks, where

N_{TS} represents the number of bundled time slots TS/TDMA frame.

Furthermore, the polling period (acknowledgement polling period) is to be taken into account, which corresponds to a memory space requirement of 32 RLC data blocks.

Successful decoding requires all of the data sub-blocks from all of the differently punctured puncturing schemes P1, P2 and P3. A maximum of (32+N_{TS}×12) data sub-blocks can be transmitted between two data sub-blocks with the same block sequence number BSN and different puncturing schemes. In the worst case, all of the data sub-blocks cannot be received correctly during this time period and have to be stored in the second memory area SB_{B} of the IR memory.

Assuming a worst case scenario, the required memory space of the IR memory according to the prior art is:
IR=SB_{A}+S_{BB}=2×(32+N_{TS}×12)+X_{D} RLC data sub-blocks.

In the case of the IR memory according to the prior art, the soft outputs of the channel equalizer are stored in the two memory areas SB_{A} and SB_{B} with the same data resolution R.

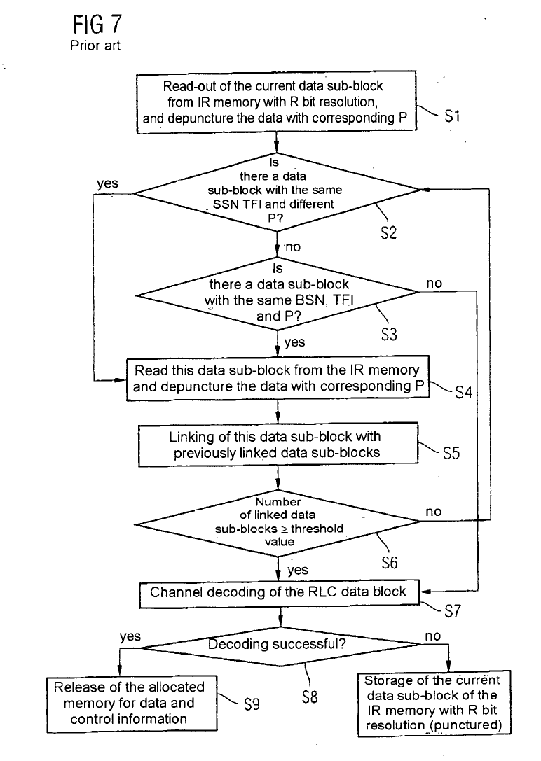

FIG. 7 shows the operation of data channel decoding in the case of an IR memory according to the prior art.

A step S1 involves reading out the current data sub-blocks from the IR memory with a predetermined data resolution of R bits and depuncturing them with the corresponding puncturing scheme P.

A step S2 involves checking whether there are further data sub-blocks with the same block sequence BSN, TFI and different puncturing schemes P.

A further step S3 involves checking whether there is a further data sub-block with the same BSN number, TFI and the same puncturing scheme P.

If the answer is yes in step S2 or step S3, this data sub-block is read out from the IR memory and the data are depunctured with the corresponding puncturing scheme P in a step S4. The soft outputs of the depunctured sub-block are combined with those of the preceding sub-blocks in a step S5.

Afterward, a step S6 involves checking whether or not the number of combined data sub-blocks has exceeded a limit value. If this is not the case, the operation returns to step S2. If the limit has been exceeded, a channel decoding of the RLC data block is effected in a step S7.

A step S8 involves checking whether the decoding procedure has been successfully concluded.

If the decoding was successful, the allocated memory space is released for the data and the control information in a step S9. If the decoding could not be concluded successfully, the current data sub-block is stored in the IR memory with a defined data resolution R.

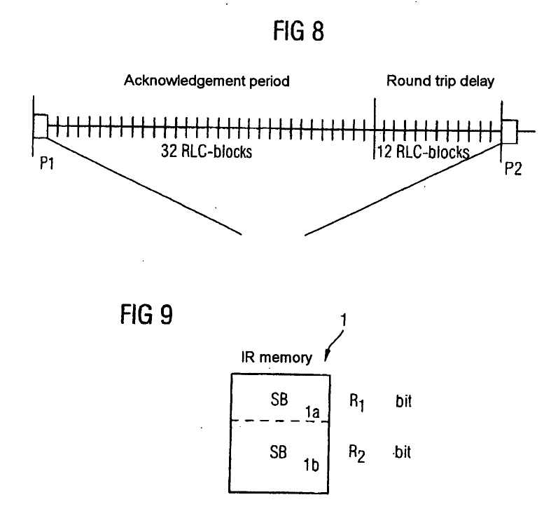

FIG. 8 schematically shows the time period required before an unacknowledged RLC block can be transmitted anew. If the decoding of the RLC data block x (which is punctured with a puncturing scheme P1) goes wrong, this data block can then be transmitted anew at the earliest after the acknowledgement period and the round trip delay have elapsed. In this case, the acknowledgement period depends on the period of the supported time slots TS. The acknowledgement period amounts to 32 RLC data blocks in the case of one time slot, 32/2 RLC data blocks in the case of two time slots TS and 32/4 RLC data blocks in the case of four time slots.

The IR memory according to the prior art as illustrated in FIG. 6 has the disadvantage that it requires a relatively large memory space. This is all the more serious since memory space is particularly tight in the mobile station.

Therefore, the object of the present invention is to provide an IR memory which has a minimal memory size.

This object is achieved according to the invention by means of an IR memory having the features specified in patent claim 1.

The invention provides an IR memory for an EGPRS receiver of a mobile station (MS), which receives data from a base station (BS) via a data transmission channel, the IR memory having:

a first memory area for buffer-storing a specific number of data blocks with a predetermined first data resolution,

a second memory area for buffer-storing erroneously decoded data blocks, the second memory area storing the non-decoded data blocks with a second data resolution (R₂), which is lower than the first data resolution (R₁).

The basic idea of the IR memory according to the invention consists in using different data resolutions for the data sub-blocks actually transmitted and the data sub-blocks that were previously decoded incorrectly. The incorrectly decoded data sub-blocks contain less reliable information and can therefore be stored with a lower data resolution in order to save memory space.

In one preferred embodiment of the IR memories according to the invention, the number of data blocks stored in the first memory area of the IR memory is provided in a manner dependent on the internal signal delay within the mobile station.

In a further preferred embodiment of the IR memory according to the invention, the number of data blocks that can be stored in the second memory area of the IR memory is provided in a manner dependent on the polling period of the data transmission channel and on the round trip delay.

In a particularly preferred embodiment of the IR memory according to the invention, the second data resolution can be set adaptively.

In this case, the second data resolution (R₂) with which the erroneously decoded data blocks are stored in the second memory area of the IR memory is set in a manner dependent on a burst data transmission signal quality measured by the receiver.

The second data resolution (R₂) can preferably be changed over between different resolution levels.

In this case, the second data resolution (R₂) is preferably 2 bits, 3 bits or 4 bits.

In a particularly preferred embodiment of the IR memory according to the invention, the data resolution (R₁) for the first memory area is 5 bits.

In one preferred embodiment of the IR memory according to the invention, said IR memory is connected, on the input side, to a reception buffer memory for the received data blocks.

The IR memory is preferably connected to a decoder on the output side.

The data blocks are preferably RLC (radio link control) data blocks.

The data blocks are preferably MCS-coded.

Preferred embodiments of the IR memory according to the invention are described below with reference to the accompanying figures for elucidating features that are essential to the invention.

In the figures:

FIG. 1 shows a base station and a mobile station according to the prior art;

FIG. 2 shows a block diagram of a transmitter within the base station (BS) according to the prior art;

FIG. 3 shows a data packet to be transmitted according to the prior art;

FIG. 4 shows a coding and puncturing scheme for data transmission according to the prior art;

FIG. 5 shows a receiver within a mobile station (MS) with an IR memory according to the prior art;

FIG. 6 shows an IR receiver according to the prior art;

FIG. 7 shows a flowchart of a channel decoding according to the prior art;

FIG. 8 shows a timing diagram for elucidating the calculation of the required memory space in the case of an IR memory according to the prior art;

FIG. 9 shows a preferred embodiment of the IR memory according to the invention;

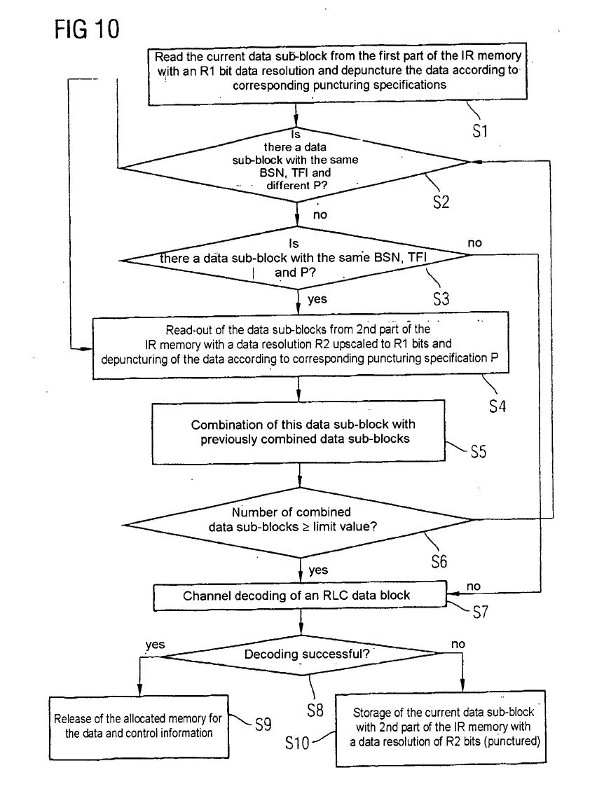

FIG. 10 shows a flowchart for elucidating the channel decoding in the case of a receiver with the IR memory according to the invention;

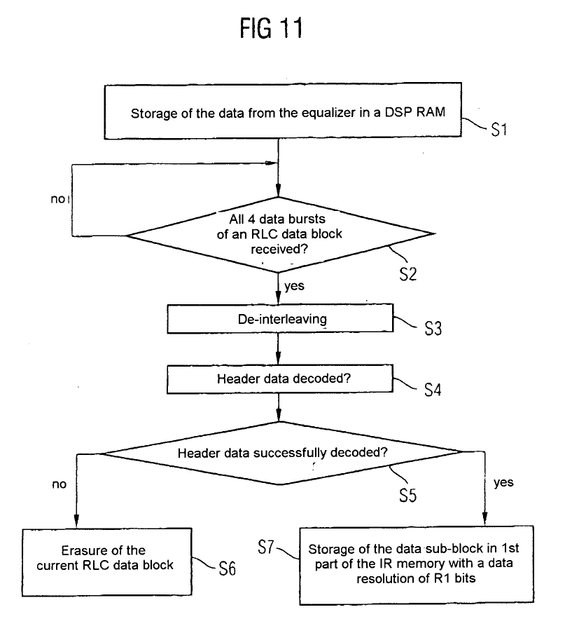

FIG. 11 shows a flowchart for illustrating the header decoding according to the invention;

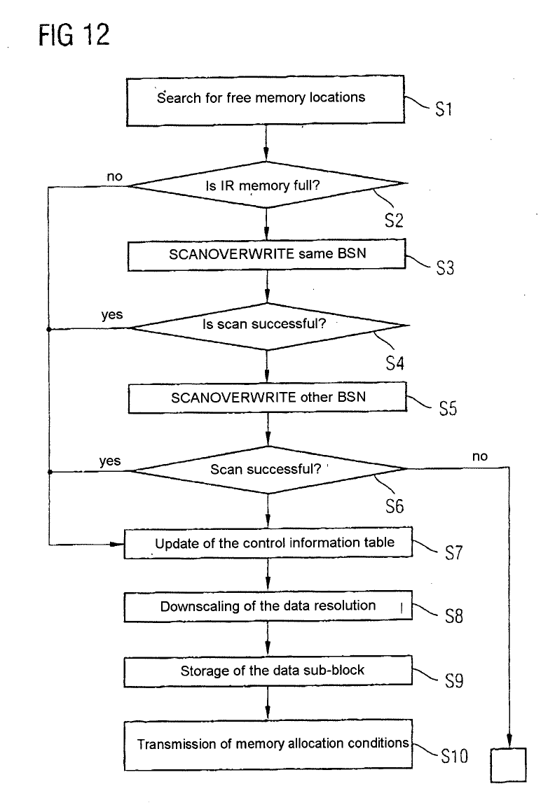

FIG. 12 shows a flowchart for elucidating the storage of a new data sub-block according to the invention;

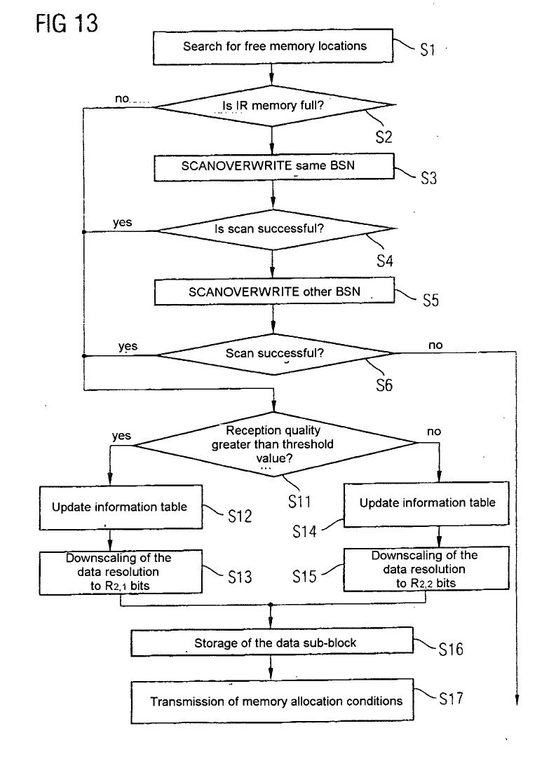

FIG. 13 shows a flowchart for illustrating the storage of a new data sub-block in a preferred embodiment according to the invention;

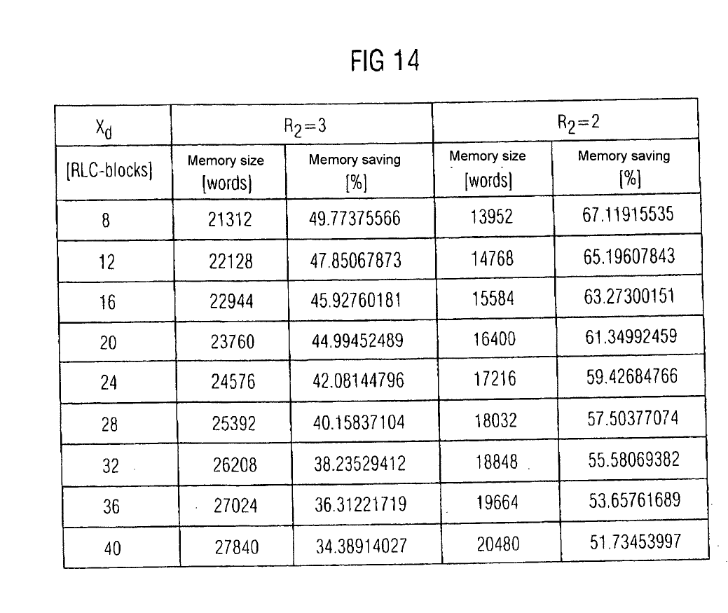

FIG. 14 shows a table for the required IR memory size dependent on the internal signal delay of the mobile station (MS) according to the invention;

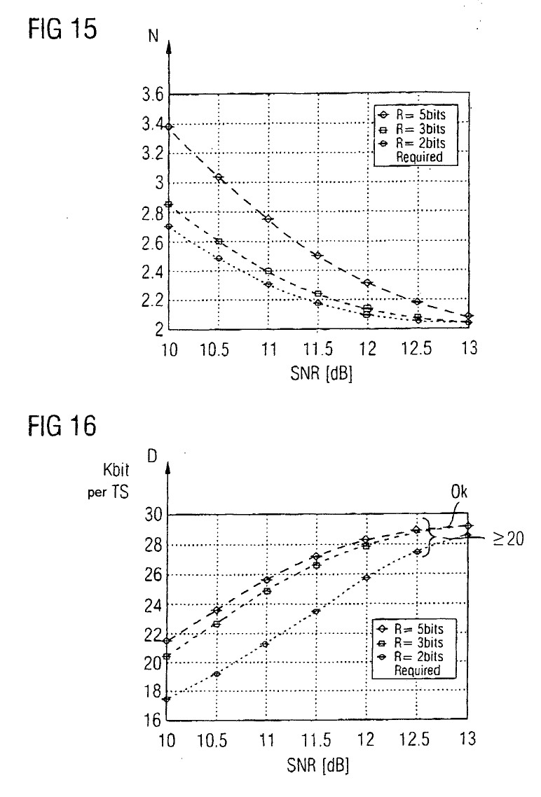

FIG. 15 shows a diagram of the required additional number of data transmissions per RLC data block as a function of the signal to noise ratio SNR and the second data resolution;

FIG. 16 shows a diagram of the available data throughput as a function of the signal to noise ratio SNR and the second data resolution (R2) of the IR memory according to the invention.

As can be discerned from FIG. 9, the IR memory 1 according to the invention has a first memory area 1a and a second memory area 1b. The first memory area 1a serves for buffer-storing a specific number of data blocks, preferably RLC data blocks, with a predetermined first data resolution R₁.

The IR memory 1 furthermore has a second memory area 1b for buffer-storing erroneously decoded data blocks. The erroneously decoded data blocks are stored with a second data resolution R₂ in the second memory area 1b of the IR memory 1, the second data resolution R₂ being lower than the first data resolution (R₁).

The number of RLC data blocks stored in the first memory area 1a of the IR memory 1 depends on the internal signal delay within the mobile station MS. In one preferred embodiment of the IR memory according to the invention, the number of RLC data blocks 12 that can be stored in the first memory area 1a of the IR memory is RLC data blocks. Each RLC data block has 612 soft outputs and in each case a 5 bit data resolution (in accordance with MCS-9) in order to bridge the signal delay Δt between the equalizer output up to the channel decoding.

In one preferred embodiment of the IR memory 1 according to the invention, the number of RLC data blocks stored in the second memory area 1b of the IR memory 1 depends on the one hand on the polling period of the data transmission channel and on the other hand on the round trip delay.

FIG. 10 shows the operation of data channel decoding using an incremental redundancy according to the invention.

A step S1 involves reading out the current data sub-blocks from the first memory area 1a of the IR memory 1 with a data resolution R₁ and depuncturing them with the corresponding puncturing specification.

A further step S2 involves checking whether a further data sub-block with the same block sequence number BSN, the same TFI (temporary frame identity) and a different puncturing scheme P is present. If this is not the case, a step S3 involves checking whether there is a further data sub-block which has the same block sequence number BSN, the same temporary frame identity TFI and the same puncturing scheme P.

If this is the case, a step S4 involves reading out this data sub-block from the second memory area 1b of the IR memory 1 with the second data resolution R₂. The data block read out is scaled upward by R₁-R₂ bits and depunctured with the corresponding puncturing specification P.

A step S5 involves combining the read-out and depunctured data sub-block with previously combined data sub-blocks.

Afterward, a step S6 involves checking whether or not the number of combined data sub-blocks has exceeded a specific limit value. If this is not the case, the operation returns to step S2.

In the converse case, the channel decoding of the RLC data block is effected in a step S7.

A step S8 involves checking whether the decoding was able to performed successfully.

If the decoding of the RLC data block was successful, the allocated memory area is released for the data and the control information in a step S9.

If the decoding of the RLC data block could not be concluded successfully, the current data sub-block is stored in the second memory area 1b of the IR memory 1 with the second data resolution R2 in a step S10.

In the case of the flowchart illustrated in FIG. 10, the second memory area 1b of the IR memory 1 has a fixed second data resolution R₂.

In one preferred embodiment of the IR memory 1 according to the invention, the second data resolution R₂ is set adaptively. In this case, the second data resolution R2 is preferably set in a manner dependent on a burst data transmission signal quality measured by the receiver. For a data transmission burst with a high signal quality, the incorrectly decoded data sub-blocks are stored for example with a data resolution R_{2,1} in the second memory area 1b; for a data burst of medium quality, a soft output data resolution R_{2,2}<R_{2,1} is used; and for a data burst of low quality, the data resolution of the second memory area is reduced to R_{2,3}<R_{2,2}<R_{2,1}. In this preferred second embodiment, the data resolution can preferably be changed over between different resolution levels of R_{2,1} bits, R_{2,2} bits or R_{2,3} bits.

A further alternative embodiment comprises switching between two different soft data resolutions for example of a resolution of R_{2,1} for data bursts of high quality and a data resolution R_{2,2}<R_{2,1} for a data burst with a low signal quality.

FIG. 11 shows the sequence of the decoding of header data in the receiver according to the invention.

In a step S1, the data received from the equalizer of the receiver are stored in a buffer memory of a digital signal processor DSP.

A step S2 involves checking whether all four data bursts of an RLC data block have been received.

If all four data bursts associated with same RLC data block are ready for the data processing, the data are de-interleaved in a step S3. The header data are subsequently decoded in a step S4.

A step S5 involves checking whether the decoding of the header data was concluded successfully.

If this is not the case, the current RLC data block is erased in a step S6. If, conversely, it is ascertained in a step S5 that the decoding of the header data was able to be concluded successfully, in a step S7 the corresponding data sub-blocks are stored in the first memory area 1a of the IR memory 1 with a data resolution R₁.

FIG. 12 shows a flowchart for the storage of a new data sub-block in the IR memory 1. Firstly, a scan IR Mem is carried out in a step S1, i.e. a search is made for free memory locations in a control information table.

If it is ascertained in a step S2 that the IR memory 1 is full, a further step S3 involves carrying out a scan-4-overwrite-same-BSN procedure, which involves overwriting all data block entries for overwriting a data sub-block version with the same block sequence BSN and the same TFI number as the current data sub-block to be stored. If no data sub-block with the same BSN number and the same TFI number can be overwritten and this is ascertained in step S4, all further data block entries are scanned or searched for in a further scan-4-overwrite-other-BSN procedure in a step S5, and a data sub-block version with a BSN and TFI number other than those of the data sub-block that is currently to be stored is overwritten.

If it is ascertained in step S6 that this scan overwrite procedure proceeded successfully, the control information table is renewed or updated in a step S7. If one of the three scan procedures carried out in steps S1, S3, S5 was able to be concluded successfully, the control information is updated by a new BSN, TFI, RX quality value and by the new puncturing scheme and also the new modulation coding scheme in step S7. If no free or overwritable memory space is present, an indication signal is transmitted to the base station BS, which indicates to the base that there is no available memory space present in the mobile station MS.

After the updating of the control information table in step S7, the soft output data resolution is scaled downward from R₁ to R₂ in a step S8.

The data sub-block is subsequently stored in a step S9. The information about the memory allocation conditions are transmitted to the microprocessor of the mobile station in a step S10.

FIG. 13 shows the procedure for the storage of a new data sub-block in an alternative embodiment, in which use is made of two different soft output data resolutions R₂ for incorrectly decoded data sub-blocks in a manner dependent on the quality of the burst signal.

If one of the scan procedures carried out in steps S1, S3, S5 has proceeded successfully, a step S11 involves checking whether the reception signal quality lies above a specific threshold value.

In a step S12, the information table is updated and a downscaling of the data resolution to R_{2,1} bits is subsequently performed in a step S12.

If, conversely, the data signal reception quality is below the threshold value, the table is correspondingly updated in a step S14 and the data resolution is downscaled to merely R_{2,2}<R_{2,1} bits in a step S15.

The data sub-block is subsequently stored in a step s16.

Finally, in a step S17, the memory allocation conditions are reported to the data processing unit.

FIG. 14 shows the total required memory size dependent on the internal signal propagation time X_{D} of the mobile station MS and the data resolution R₂ used for the second memory area 1b. For compensating for the internal signal propagation time within the mobile telephone, it is necessary to provide memory space for 12 RLC data blocks.

For a conventional IR memory with a uniform data resolution of 5 bits, for example, the memory size amounts to
S_{IR}=3×204×{2×(32+N_{TS}×12)×5+X_{D}×5} bits

The memory size for an IR memory 1 according to the invention amounts to:
S_{IR}=3×204×{2×(32+N_{TS}×12)×R₂+X_{D}×R₁} bits

For four time slots and a data resolution of the second memory area 1b of R₂=2 or R₂=3, the required IR memory size thereby results as:
S_{IR,2}=(12 320+304×X_{D}) each of 16 bits
or
S_{IR,3}=(19 860+204×x_{D}) data words each having 16 bits.

The lower the second data resolution R₂ chosen for the second memory area 1b, the higher the saving of memory space of the IR memory 1 achieved. With an assumed signal propagation delay X_{D} of 12 RLC data blocks, by way of example, the memory space saving amounts to 47.85% when using a data resolution R₂=3 bits and 65.196% when using a second data resolution R₂=2 bits.

Even better results can be obtained with an adaptive adaptation of the second data resolution R₂ in a manner dependent on the measured data burst quality.

FIG. 15 shows the required number N of data transmissions per RLC data block as a function of the signal to noise ratio SNR for different second data resolutions R2 of the IR memory 1.

As can be discerned from FIG. 15, the number of required data transmissions per RLC data blocks, for example with an assumed signal to noise ratio SNR of 12.5 dB, at a data resolution of 3 bits, is almost exactly the same magnitude as for a data resolution of 5 bits.

FIG. 16 shows the available data throughput D in kilobits per time slot TS as a function of the signal to noise ratio and the data resolution used.

As can be gathered from FIG. 16, the data throughput per time slot, with an assumed signal to noise ratio of 12.5 dB, at a data resolution used of 5 bits, is only very slightly higher than at a data resolution used of only 3 bits.

The IR memory 1 according to the invention therefore makes it possible to achieve a significant memory space reduction without the number of required data transmissions per RLC block increasing and without the data throughput per time slot being significantly reduced.

1. An IR memory for an EGPRS receiver of a mobile station, which receives data from a base station via a data transmission channel, the IR memory having:
a) a first memory area for buffer-storing a specific number of data blocks with a predetermined first data resolution;
b) a second memory area for buffer-storing erroneously decoded data blocks,
c) the second memory area storing the erroneously decoded data blocks with a second data resolution, which is lower than the first data resolution, and
d) it being possible for the second data resolution with which the erroneously decoded data blocks are stored in the second memory area of the IR memory to be changed over adaptively between different resolution levels in a manner dependent on a burst data transmission signal quality measured by the receiver.

2. The IR memory as claimed in claim 1, wherein the number of data blocks that can be stored in the first memory area of the IR memory depends on the internal signal delay within the mobile station.

3. The IR memory as claimed in claim 1, wherein the number of data blocks that can be stored in the second memory area of the IR memory depends on the polling period of the data transmission channel and on the round trip delay.

4. The IR memory as claimed in claim 1, wherein the resolution levels of the second data resolution are 2 bits, 3 bits or 4 bits.

5. The IR memory as claimed in claim 1, wherein the first data resolution is 5 bits.

6. The IR memory as claimed in claim 1, wherein the IR memory is connected, on the input side, to a reception buffer memory for data blocks.

7. The IR memory as claimed in claim 1, wherein the IR memory is connected to a decoder on the output side.

8. The IR memory as claimed claim 1, wherein the data blocks are RLC data blocks.

9. The IR memory as claimed in claim 1, wherein the data blocks are MCS-coded.
